(19) United States
(12) Patent Application Publication
(10) Pub. No.: US 2021/0253193 A1
(43) Pub. Date: Aug. 19, 2021

(54) SMART ELECTRIC SCOOTER WITH COMMUNICATION CAPABILITIES

(71) Applicant: Chengbang Liu, Piedmont, CA (US)

(72) Inventor: Chengbang Liu, Piedmont, CA (US)

(21) Appl. No.: 16/792,305

(22) Filed: Feb. 17, 2020

(51) Int. Cl. B62J 45/20; B60L 53/51; B60L 53/60; B62J 43/30; B62K 21/00

(52) U.S. Cl. CPC B62J 45/20; B60L 53/51; B60L 53/60; G01S 19/42; B62K 21/00; B60L 2200/12; B62J 43/30

(57) ABSTRACT

Provided is a smart electric scooter with solar-powered battery pack and light-chasing capability. In some embodiments, the smart electric scooter comprises: a solar panel attached to the electric scooter; a battery pack electrically connected to the solar panel; a steering assembly comprising a plurality of wheels and an electronic motor; a location tracking device; a broadcasting transmitter; a receiver; and a data processing circuit configured to: obtain current location information from the location tracking device, wherein the current location information corresponds to a current location of the electric scooter; obtain a current charging efficiency of the battery pack at the current location; broadcast the current location information and the current charging efficiency through the broadcasting transmitter in response to the current charging efficiency being greater than a first predetermined threshold.

### TECHNICAL FIELD

This disclosure relates to generally to electric scooters, and more specifically to smart solar-powered electric scooters with communication capabilities.

### BACKGROUND

Public electric scooters often face challenges to charge the batteries as they are primarily located in outdoor environments. A solar-powered battery may utilize solar energy to charge the battery when the connected solar panel are placed under a source of light. However, some scooters with solar-powered batteries may sometimes be unable to detect light sources (e.g., the scooters are placed in shade, the light sources are blocked by walls).

### SUMMARY

In general, one aspect disclosed features an electric scooter, comprising: a solar panel attached to the electric scooter; a battery pack electrically connected to the solar panel; a steering assembly comprising a plurality of wheels and an electronic motor; a location tracking device; a broadcasting transmitter; a receiver; and a data processing circuit configured to: obtain current location information from the location tracking device, wherein the current location information corresponds to a current location of the electric scooter; obtain a current charging efficiency of the battery pack at the current location; broadcast the current location information and the current charging efficiency through the broadcasting transmitter in response to the current charging efficiency being greater than a first predetermined threshold; obtain first data received by the receiver, the first data comprising a first target location and a first battery charging efficiency at the first target location; compare the first charging efficiency and the current charging efficiency; and in response to the first charging efficiency is greater than the current charging efficiency: identify a first direction towards the first target location; determine a first set of one or more movements; and send control signals to the steering assembly causing the steering assembly to execute the first set of one or more movements.

Embodiments of the electric scooter may include one or more of the following features.

In some embodiments, the data processing circuit is further configured to: skip identifying the first direction if the current charging efficiency for the battery pack is greater than a predetermined threshold.

In some embodiments, the data processing circuit is further configured to: skip identifying the first direction towards the first target location if the first charging efficiency at the first target location is less than the current charging efficiency.

In some embodiments, the data processing circuit is further configured to: skip identifying the first direction towards the first target location if a difference between the first charging efficiency and the current efficiency is less than a predetermined margin.

In some embodiments, the data processing circuit is further configured to: determine a first distance between the current location and the first target location.

In some embodiments, the data processing circuit is further configured to: skip identifying the first direction towards the first target location if the first distance is greater than a predetermined distance-threshold.

In some embodiments, the data processing circuit is further configured to: determine a first score corresponding to the first target location, based on the first distance and the first charging efficiency; and skip identifying the first direction towards the first target location if the first score is less than a predetermined score-threshold.

In some embodiments, the electric scooter may further comprise: obtain second data received by the receiver, the second data comprising a second target location and a second battery charging efficiency at the second target location.

In some embodiments, the data processing circuit is further configured to: in response to the second charging efficiency is greater than the current charging efficiency and the first charging efficiency: identify a second direction towards the second target location; determine a second set of one or more movements; and send control signals to the steering assembly causing the steering assembly to execute the second set of one or more movements.

In some embodiments, the data processing circuit is further configured to: determine a second distance between the current location and the second target location; determine a second score corresponding to the second target location, based on the second distance and the second charging efficiency; select a candidate location from the first target location and the second target location by comparing the first score and the second score; identify a third direction towards the candidate location; determine a third set of one or more movements; and send control signals to the steering assembly causing the steering assembly to execute the third set of one or more movements.

In some embodiments, the electric scooter further comprises one or more proximity sensors, wherein the one or more proximity sensors are able to detect proximities of objects relative to the electric scooter.

In some embodiments, the data processing circuit is further configured to: in response to an obstacle in the identified direction being detected by the one or more proximity sensors, send control signals to the steering assembly causing the electric scooter to stop moving.

In some embodiments, the data processing circuit is further configured to: in response to an obstacle in the determined direction being detected by the one or more proximity sensors, send control signals to the steering assembly causing the electric scooter to avoid the obstacle.

In some embodiments, the data processing circuit is further configured to: after avoiding the obstacle, determine a new set of one or more movements for the steering assembly to execute.

### BRIEF DESCRIPTION OF THE DRAWINGS

FIG. 1 illustrates example electric scooters according to embodiments of the disclosed technology.

FIG. 2 illustrates further detail of an electric scooter of FIG. 1.

FIG. 3 illustrates an example system diagram of the electric scooters of FIG. 1.

FIG. 4A illustrates an example setup for the electric scooters of FIG. 1 to navigate towards a light source.

FIG. 4B illustrates another example setup for the electric scooters of FIG. 1 to navigate towards a light source.

FIG. 5 illustrates yet another example setup for the electric scooters of FIG. 1 to navigate towards a light source.

FIG. 6A illustrates an example method for the electric scooters of FIG. 1 to broadcast location information.

FIG. 6B illustrates an example method for the electric scooters of FIG. 1 to navigate towards a light source.

FIG. 6C illustrates another example method for the electric scooters of FIG. 1 to navigate towards a light source.

### DETAILED DESCRIPTION

Embodiments of the described technology provide an electric scooter having solar-powered batteries electrically coupled with a solar panel, proximity sensors, a steering assembly, an information transmitter and receiver, and a data processing circuit. The solar-powered batteries may be charged by the solar panel when the panel is exposed to a light source. In some embodiments, besides using solar power to charge, the solar-powered batteries may be charged in other ways, such as replacing discharged batteries with back-up batteries, removing the batteries and connecting it to an external charger that is plugged into a regular power outlet, using retractable cord to plug in a regular power outlet. In some embodiments, the solar-powered batteries and the solar panel are electrically connected via a charging controller.

In some embodiments, the electric scooter may include a location tracking device (e.g., a GPS tracker) to locate its current location. In some embodiments, the proximity sensors installed on the electric scooter may be able to detect obstacles. In some embodiments, the electric scooter may be equipped with a transmitter and a receiver for exchange information with other electric scooters within a range. In some embodiments, the electric scooter may also include a battery monitor that monitors the batteries' status (e.g., remaining capacity, charging efficiency).

In some embodiments, the electric scooter may comprise a data processing circuit configured to receive various data, including: the current location of the scooter, the current charging efficiency of the batteries, data received by the receiver, other suitable data, or any combination thereof. In some embodiments, the data processing circuit may also be configured to control the steering assembly, determine whether to broadcast information through the transmitter, identify a direction to move towards, determine movements to be executed by the steering assembly, or perform another suitable action.

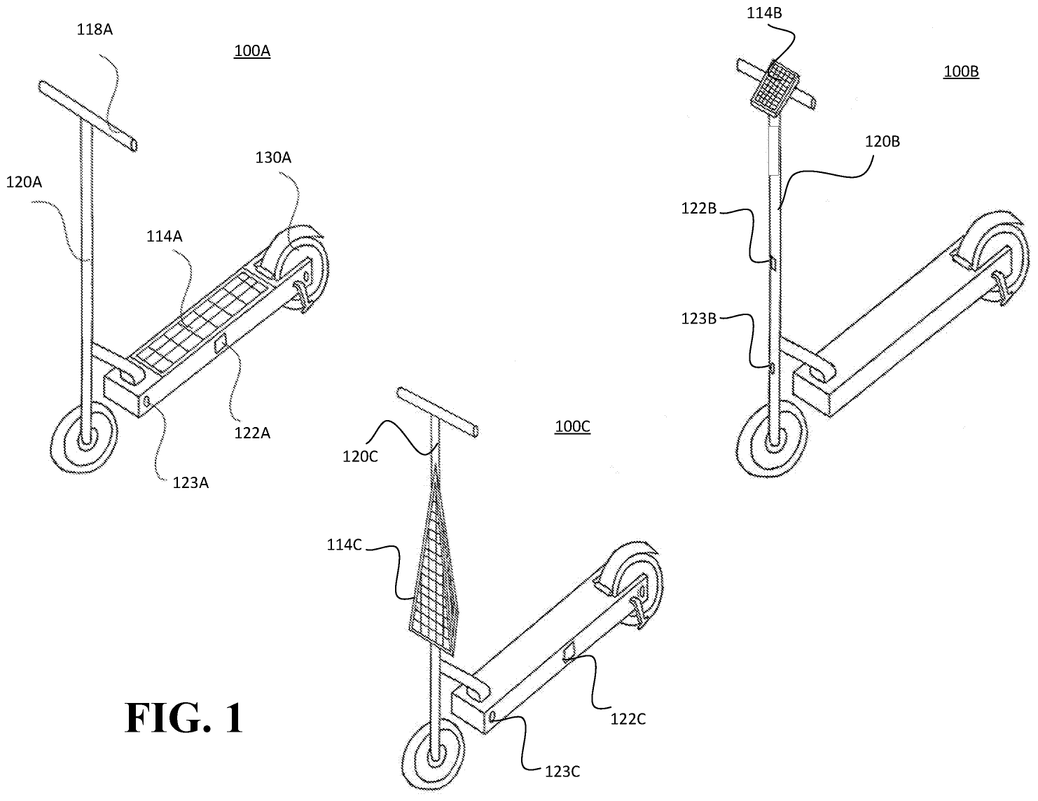

FIG. 1 illustrates example electric scooters 100A, 100B, and 100C according to embodiments of the disclosed technology. Referring to FIG. 1, the scooter 100A includes a deck assembly attached to a frame of the scooter 100A. The deck assembly includes a battery case 106 mounted underneath the deck (or within the deck). The battery case includes one or more batteries (not shown). The batteries are electrically coupled to an electric drive motor protected by a housing. A solar panel 114A may be attached to the upper surface of the deck assembly, and electrically coupled with batteries in the battery case. The solar panel 114A may include a plurality of solar cells. The batteries may be charged by the solar panel 114A when the solar panel 114A is placed under a source of light, another suitable way of charging (e.g., regular plug-in charging), or any combination thereof.

The scooter 100A in FIG. 1 may be steered by turning a handlebar 118A. The speed of the motor may be controlled using a throttle mounted on the handlebar 118A. The handlebar 118A may be connected to the frame by a bar 120A. The scooter 100A includes a plurality of wheels 130A. In some embodiments, the scooter 100A may include three or more wheels so that it is self-balanced. The wheels 130A, the electric motor, the handlebar 118A, and the bar 120A may be referred to as a steering assembly.

The scooter 100A in FIG. 1 may be equipped with one or more proximity sensors 122A and a transceiver 123A (or a separate transmitter and a separate receiver).

The components such as solar panel 114A, the proximity sensors 122A and the transceiver 123A on the example scooter 100A may be placed at different locations. For example, as shown in another example scooter 110B, the solar panel 114B may be placed on the handle bar, and the proximity sensors 122B and the transceiver 123B may be installed on the bar 120B. As another example, as shown in another example scooter 100C, the solar panel 114C may be in a pyramid shape with three triangular joint panels (e.g., a tetrahedron) connected at an apex. The three panels may be facing three different directions and jointly cover 360 degrees. The three panels may also be tilted upwards for a small degree (e.g., 30 degrees) to better receive light energies. The proximity sensors 122C and the transceiver 123C may be installed on the frame of the scooter 100C.

The transceivers (123A, 123B, and 123C) on the example scooters 100A, 100B, and 100C in FIG. 1 may each include a transmitter and a receiver for exchange information with other scooters. In some embodiments, the transmitter and the receiver may be combined into one device, referred as to a transceiver. In this specification, the transmitter or the receiver may refer to an individual device offering the corresponding functionality, or the corresponding functionality of a combined device (e.g., a transceiver). The example scooters in FIG. 1 may also include a GPS tracker or another suitable location tracking device to identify its current location.

Each of the example electric scooters 100A, 100B, and 100C depicted in FIG. 1 may also have a data processing circuit (not shown). The data processing circuit may be configured to receive data collected by the one or more sensors, process the received data, send control signals to control the electric motor and/or steer the scooter, exchange information with the transmitter and the receiver, or to perform other suitable operations.

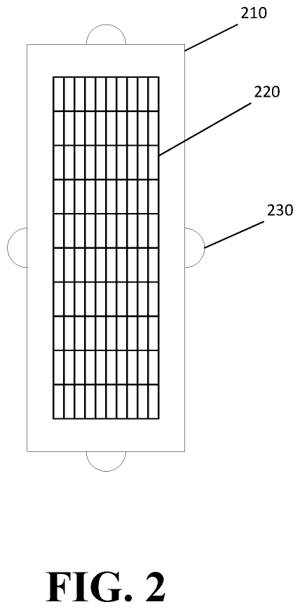

FIG. 2 illustrates further detail of the electric scooter 100A of FIG. 1. Referring to FIG. 2, the deck assembly 210 may have a solar panel 220 attached to its upper surface, and four proximity sensors 230 installed on each of the four sides (e.g., front, left, back, and right). The proximity sensors 230 may measure the distances of objects surrounding the scooter from the four directions. The data processing circuit may receive the measured distances, and determine if there is an obstacle within a distance in the scooter's moving direction.

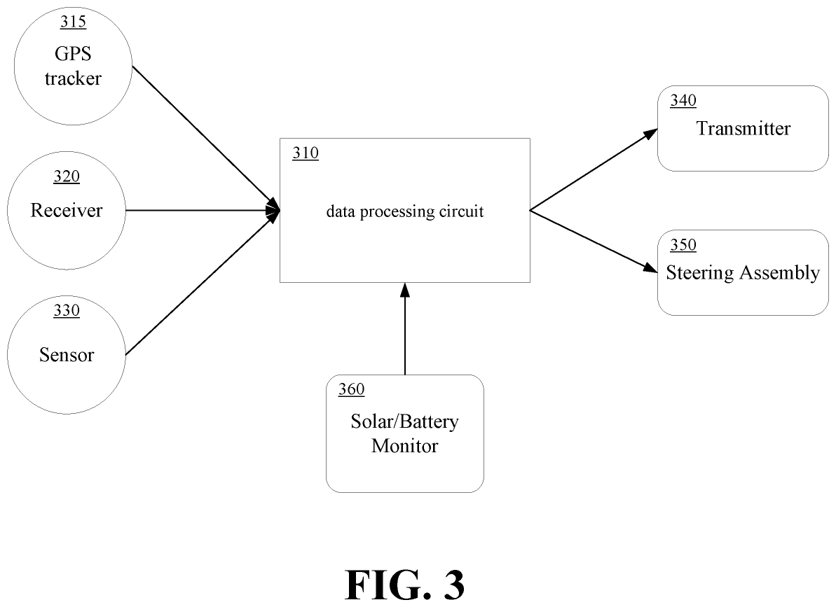

FIG. 3 illustrates an example system diagram of the electric scooters of FIG. 1. As shown in FIG. 3, the data processing circuit 310 may receive information from a GPS tracker 315, a receiver 320, one or more proximity sensors 330, and a solar/battery monitor 360 monitoring the solar-powered batteries (e.g., the monitor monitors the status of the batteries or the charging controller connecting the solar panel and the batteries). In some embodiments, the GPS tracker 310 may refer to a device that obtains the scooter's current location. In some embodiments, the receiver 320 may receive information broadcasted from another scooter (e.g., by using the other scooter's transmitter). The information may comprise the other scooter's current location, the other scooter's battery status (e.g., charging efficiency), another suitable information, or any combination thereof. In some embodiments, the proximity sensors 330 may detect obstacles or other objects. Based on the data received from the GPS tracker 315, the receiver 320 and the proximity sensors 330, the data processing circuit 310 may determine whether to move, a direction to move, or one or more movement to avoid an obstacle. In some embodiments, the data processing circuit 310 may obtain the scooter's battery status (e.g., remaining capacity, and/or charging efficiency) from the solar/battery monitor 360.

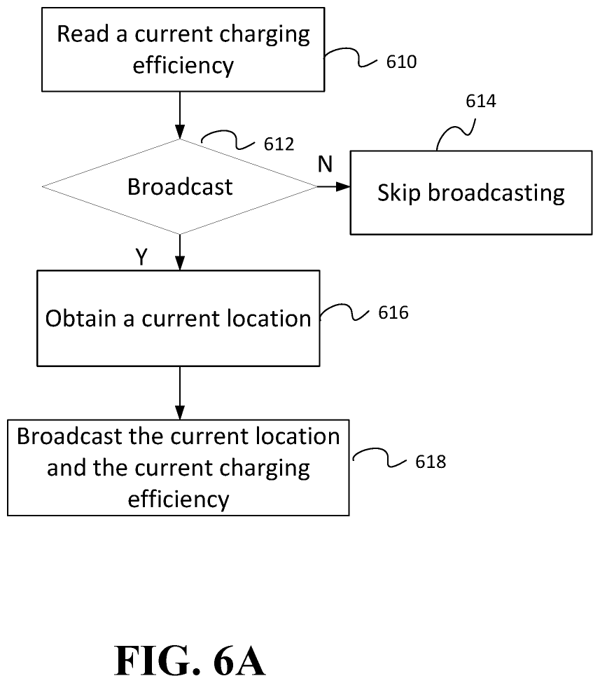

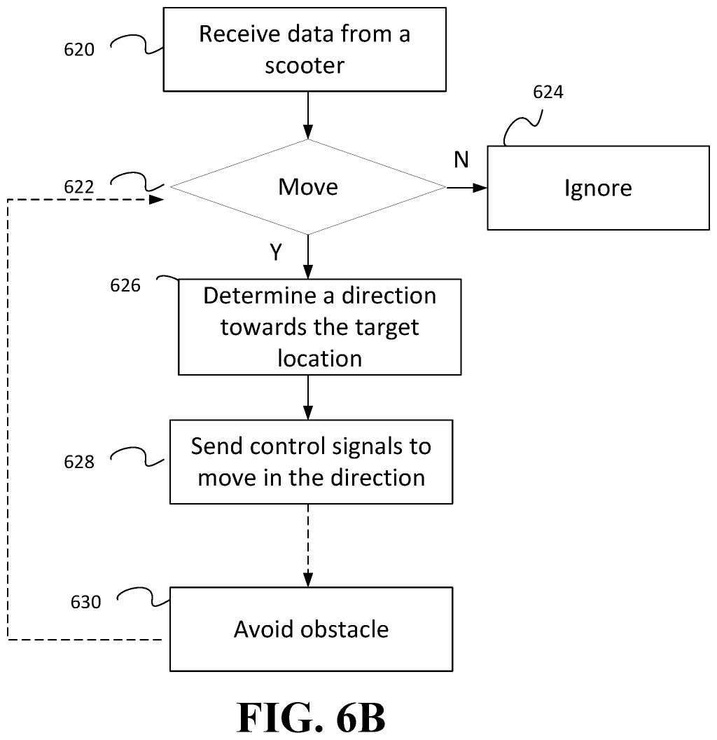

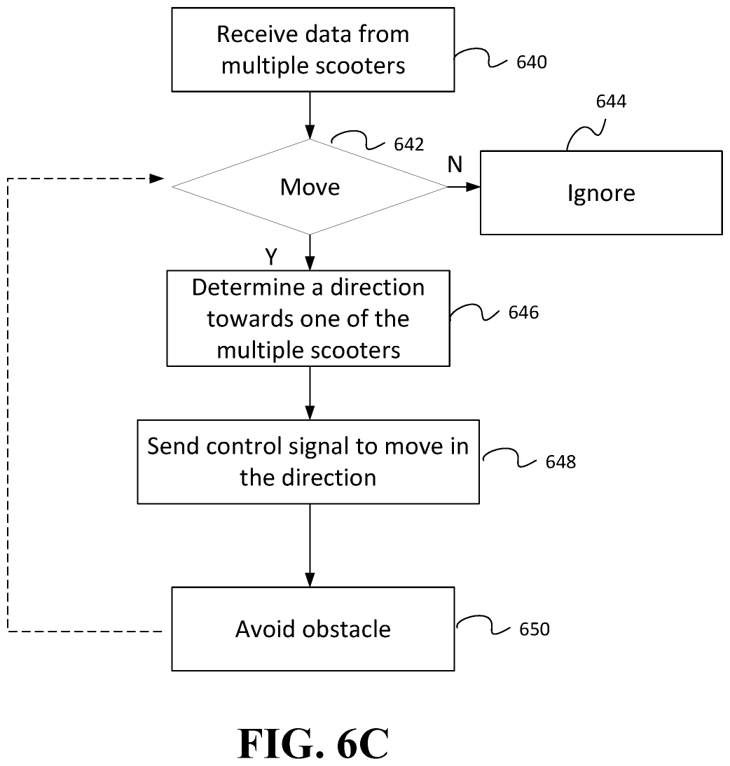

As shown in FIG. 3, the data processing circuit 310 may send information to a transmitter 340 and a steering assembly 350. In some embodiments, in response to certain conditions being satisfied, the data processing circuit 310 may determine to broadcast the scooter's current location (collected by the GPS tracker 315) and the charging efficiency data (collected by the solar/battery monitor 360) through the transmitter to other scooters within a range (e.g., a range determined by the capacity of the transmitter 360). The certain conditions are explained in detail in FIG. 6A. In some embodiments, after the data processing circuit 310 determines one or more movements to move the scooter (e.g., the movements comprise a direction, and a distance), it may send corresponding control signals to the steering assembly 350 to execute the one or more movements. The one or more movements are explained in detail in FIGS. 6B, 6C, and 6D.

In some embodiments, when the one or more movements are insufficient to relocate the electric scooter to the target location (e.g., the target location received by the receiver), after the previous movements being executed, the data processing circuit may determine a new set of one or more movements to keep moving in the target direction or towards the target location, and send corresponding control signals to the steering assembly to execute the new movements.

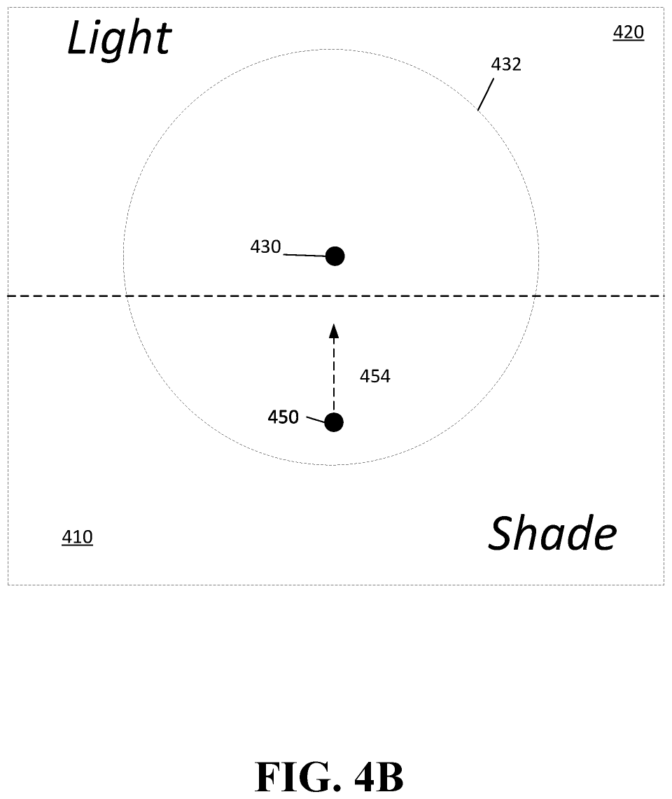

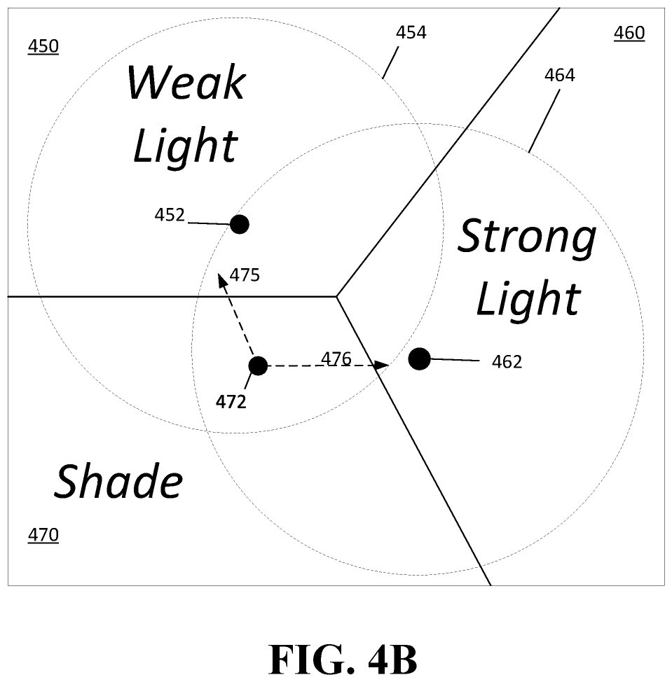

FIG. 4A illustrates an example setup for the electric scooters of FIG. 1 to navigate towards a light source. As shown in FIG. 4A, the example setup includes one area under a light source 420, and another area in shade 410. The scooters 430 is in the area 420 under the light, and the scooter 450 is in the area 410 under the shade.

The scooter 430 in FIG. 4A is located under the light source and the solar panel on the scooter 440 may convert the light photons into electrons and charge the batteries. When the data processing circuit of the scooter 440 determines that the charging efficiency of its batteries is beyond a predetermined threshold (e.g., indicating the intensity of the light source is beyond a threshold), it may broadcast various information through a transmitter to other scooters within a broadcasting range 432. The various information may include a current location, the charging efficiency (e.g., in the form of a score representing the charging speed), an identifier associated with the scooter 440, another suitable information, or any combination thereof. As shown in FIG. 4A, the scooter 450 is within the broadcasting range of the scooter 440, and thus may receive the broadcasted information.

Referring to the scooter 450 in FIG. 4B, since it is located in the shade, its charging efficiency (e.g., using the solar panel) may be low. However, since the scooter 450 received the information broadcasted from the scooter 430, including the current location and charging efficiency of the scooter 430. If the data processing circuit of the scooter 450 determines the received charging efficiency is greater than the scooter 450's current charging efficiency, it may identify a direction 454 towards the current location of the scooter 430. According to the identified direction 454, the data processing circuit may instruct the steering assembly of the scooter 450 to execute certain actions to move towards the direction 454.

FIG. 4B illustrates another example setup for the electric scooters of FIG. 1 to navigate towards a light source. In FIG. 4B, the area includes an area with a weak light source 450, an area with a strong light source 460, and an area under a shade 470. The scooter 452 is located in the area 450, the scooter 462 is located in the area 460, and the scooter 472 is located in the area 470.

As shown in FIG. 4B, both the scooters 452 and 462 may determine that their current battery charging efficiencies are greater than a predetermined threshold (e.g., the first predetermined threshold), and broadcast their current locations and other information (e.g., charging efficiencies) to scooters within their broadcasting ranges. For example, the scooter 452 may have a broadcasting range noted as 454 in FIG. 4B, and the scooter 462 may have a broadcasting range noted as 464 in FIG. 4B.

Since the scooter 472 is within both broadcasting ranges 454 and 464, it may receive information from both scooters 452 and 462. In some embodiments, before deciding to move to a new location, the data processing circuit of the scooter 472 may first determine whether its current battery charging efficiency is beyond a predetermined threshold (e.g., a second predetermined threshold). For example, if the current battery charging efficiency is fast enough (e.g., greater than the predetermined threshold), the data processing circuit of the scooter 472 may decide not to move, despite the fact that the scooters 452 and 462 may have faster charging speed. In some embodiments, this threshold may be referred as to a high-watermark threshold.

In some embodiments, the data processing circuit of the scooter 472, after receiving data from both scooters 452 and 462 (or other scooters), may select one of the scooters to determine the target location to move towards. This target location selection process may consider various factors, such as the charging efficiency at the current location, the charging efficiency at the target location, the distance between the scooter's current location and the target location, other suitable factors, or any combination thereof.

In some embodiments, the data processing circuit of the scooter 472 may first ignore the scooters (and the corresponding target locations) whose charging efficiencies are lower than its current charging efficiency. In some embodiments, the scooter 472 may select one scooter (and the corresponding target location) with the highest charging efficiency (e.g., indicating the corresponding target location is under a strong light source), and determine a direction to move towards the corresponding target location. In the example setup shown in FIG. 4B, since the scooter 462 is under the strong light source, it may have a faster charging efficiency compared to the scooter 452 that is under the weak light source. As a result, between the target locations associated with scooters 452 and 462, the data processing circuit of scooter 472 may pick scooter 462 over scooter 452, and determine the direction 476 to move the scooter 472 towards.

In some embodiments, besides considering the charging efficiencies at the target locations, the data processing circuit of the scooter 472 may also consider the distances between its current location and the target locations. For example, the data processing circuit of the scooter 472 may score the multiple target locations using the following function:

$$score ( {charging}_{current} , {charging}_{target} , distance ) = \frac{{charging}_{target} - {charging}_{current}}{distance}$$

As indicated in the above equation, even though a first target location is under a stronger light source, the scooter 473 may not select it as the destination if the distance is large. In the example setup shown in FIG. 4B, assuming the distance between the scooter 452 and scooter 472 is smaller than the distance between the scooter 462 and the scooter 472, the scooter 472 may pick scooter 452 over scooter 462 despite the fact that the scooter 462 is experiencing a faster charging efficiency.

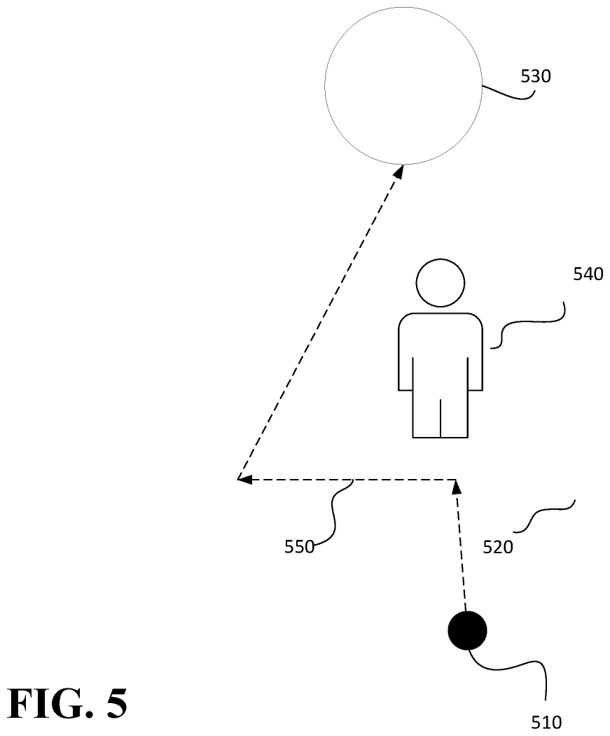

FIG. 5 illustrates another example setup for the electric scooters of FIG. 1 to navigate towards a target location. The scooter 510 in FIG. 5 may be equipped with various sensors including proximity sensors. The proximity sensors may measure the distances of objects relative to the scooter. For example, the proximity sensors may be used to detect obstacles in the direction that the scooter is moving towards. As shown in FIG. 5, the scooter 510, while moving towards the target location 530 (in the direction 520), detects an obstacle 540 blocking it from moving forward. In some embodiments, the data processing circuit of the scooter 510 may adjust the navigation direction to avoid the object 550. For example, the data processing circuit may control the scooter to move towards a new direction 550 for a predetermined distance. This operation may be repeat for multiple times until there is no obstacle in the direction towards the target location 530. In other embodiments, the data processing circuit of the scooter 510 may stop the scooter from making further movements (e.g., canceling the one or more movements being performed).

After the target location 530 is determined, the data processing circuit of the scooter 510 may send control signals to the electronic motor (and the steering assembly) to navigate the scooter 510 in the direction 520 towards the target location 530. In some embodiments, the scooter 510 may detect obstacles 550 in the path between its current location and the target location 530. For example, the scooter 510 may be equipped with one or more proximity sensors that detect objects within a predetermined proximity. In response to an object 550 in the way being detected, the data processing circuit of the scooter 510 may adjust the navigation direction to avoid the object 550. For example, the data processing circuit may control the scooter to move towards a new direction 550 for a predetermined distance. This operation may be repeat for multiple times until there is no obstacle in the direction towards the target location 530.

FIG. 6A illustrates an example method for the electric scooters of FIG. 1 to broadcast location information. As shown in FIG. 6A, the scooter may include a solar/battery monitor that monitors the status of the solar-powered batteries, e.g., a remaining capacity of the batteries, a charging efficiency representing the charging speed by using the solar panel. The monitor may read the current charging efficiency at step 610, and send such reading to the data processing circuit. The data processing circuit of the scooter may then determine whether to broadcast at step 612. In some embodiments, if the current charging efficiency is greater than a predetermined threshold (e.g., when the charging efficiency indicates the intensity of the light source at the current location is strong enough), the data processing circuit may proceed to obtain the scooter's current location at step 616, and broadcast the current location and the current charging efficiency at step 618 to other scooters within a broadcasting range. If the current charging efficiency is below the predetermined threshold, the data processing circuit may decide to skip broadcasting at step 614.

FIG. 6B illustrates an example method for the electric scooters of FIG. 1 to navigate towards a target location under a light source. As shown in FIG. 6B, the receiver on a first scooter may receive broadcasted data from a second scooter at step 620. The second scooter may be located under a light source and experiencing a high charging efficiency using the solar panel. FIG. 6A details the steps when the second scooter may determine to broadcast its information. The data processing circuit of the first scooter may then determine whether to move to the second scooter at step 622. The determination may be based on various factors, such as the first scooter's current charging efficiency, the second scooter's charging efficiency, the distance between the first and second scooters, another suitable factor, or any combination thereof. For example, if the first scooter is currently located under a shade and the charging efficiency is close to 0 (e.g., almost the worst), the data processing circuit of the first scooter may determine to move towards the target location (e.g., where the second scooter is located) without considering the distance to the target location. As another example, even though the second scooter may be located at a place under a strong light source, the data processing circuit of the first scooter may still ignore the received data at step 624 if the distance between the two scooters is beyond a distance-related threshold. As another example, the data processing circuit of the first scooter may generate a score for the second scooter based on the received data, and ignore the data if the score is below a score-related threshold. As another example, if the scooter's current charging efficiency is already at a high level (e.g., beyond a high-watermark threshold), the data processing circuit may ignore the received data at step 624.

Once the data processing circuit determines to move to the light source, it may need to first determine a direction towards the target location at step 626 (described in detail in FIG. 2). Subsequently, the data processing circuit may send corresponding control signals to the scooter's steering assembly to move in the direction for a predetermined distance at step 628. During this moving process, the data processing circuit may need to cancel the movement or generate a new set of movements to avoid obstacles at step 630 (described in detail in FIG. 5). In some embodiments, the scooter may be moved to a new location after performing the previously determined movements (e.g., moving in the direction for the predetermined distance, or avoiding obstacles). The data processing circuit may then need to repeat the process from step 620 in order to eventually arrive at the target location (e.g., light source). For example, if the charging efficiency at the new location is improved and beyond the high-watermark threshold, the data processing circuit may decide to stop moving at step 624.

FIG. 6C illustrates another example method for the electric scooters of FIG. 1 to navigate towards a target location. As shown in FIG. 6C, the receiver of a scooter may receive data from multiple scooters (e.g., each data including a location and the corresponding charging efficiency at that location) at different locations at step 640. The data processing circuit of the scooter may then determine whether to move towards one of multiple scooters at step 642. The determination may be based on various factors, such as the relationship between the scooter's current charging efficiency and the received charging efficiencies. For example, if the current charging efficiency is higher than the high-watermark threshold or the received charging efficiencies (e.g., in the received data), the data processing circuit may ignore the received location at step 644.

In some embodiments, the multiple scooters broadcasting data may be co-located in an area (e.g., in a close proximity). If the data processing circuit of the current scooter determines that the received locations (e.g., in the received data) are within a predetermined close range, it may pick the data received from one of the multiple scooters to represent the other scooters.

In some embodiments, once the data processing circuit determines to move at step 642, it may determine a direction towards one of the received locations at step 646, and then send control signals to the scooter's steering assembly to move in the direction at step 648. In some embodiments, the data processing circuit may focus on the received charging efficiencies and pick the scooter with the fastest charging speed to determine the target location. This approach may ignore the distances between the current scooter and the broadcasting scooters.

In some embodiments, the data processing circuit may also consider distances when determining the target location. For example, the received locations (corresponding to the multiple scooters) may be scored by the data processing circuit based on the corresponding distances from the current location and the corresponding charging efficiencies. A longer distance may reduce a score, and a faster charging speed may increase the score. Based on the scores, the data processing circuit may identify the scooter with the highest score to determine the target location at step 646.

Subsequently, the data processing circuit may send control signals to the steering assembly of the scooter to execute one or more movements so that the scooter is moving towards the target location at step 648. During this moving process, the data processing circuit may need to adjust or cancel the current movement or generate a new set of movements to avoid obstacles at step 650. In some embodiments, the scooter may be moved to a new location after performing the previously determined movements (e.g., moving in the direction for the predetermined distance, or avoiding obstacles). The data processing circuit may then need to repeat the process from step 642, where it determines whether to move based on the relationship between the charging efficiency at the new location and the received charging efficiency at the target location.

What is claimed is:

1. An electric scooter, comprising:
a solar panel attached to the electric scooter;
a battery pack electrically connected to the solar panel;
a steering assembly comprising a plurality of wheels and an electronic motor;
a location tracking device;
a broadcasting transmitter;
a receiver; and
a data processing circuit configured to:
obtain current location information from the location tracking device, wherein the current location information corresponds to a current location of the electric scooter;
obtain a current charging efficiency of the battery pack at the current location;
broadcast the current location information and the current charging efficiency through the broadcasting transmitter in response to the current charging efficiency being greater than a first predetermined threshold;
obtain first data received by the receiver, the first data comprising a first target location and a first battery charging efficiency at the first target location;
compare the first charging efficiency and the current charging efficiency; and
in response to the first charging efficiency is greater than the current charging efficiency:
identify a first direction towards the first target location;
determine a first set of one or more movements; and
send control signals to the steering assembly causing the steering assembly to execute the first set of one or more movements.

2. The electric scooter of claim 1, wherein the data processing circuit is further configured to:
skip identifying the first direction if the current charging efficiency for the battery pack is greater than a second predetermined threshold.

3. The electric scooter of claim 1, wherein the data processing circuit is further configured to:
skip identifying the first direction towards the first target location if the first charging efficiency at the first target location is less than the current charging efficiency.

4. The electric scooter of claim 1, wherein the data processing circuit is further configured to:
skip identifying the first direction towards the first target location if a difference between the first charging efficiency and the current efficiency is less than a predetermined margin.

5. The electric scooter of claim 1, wherein the data processing circuit is further configured to:
determine a first distance between the current location and the first target location.

6. The electric scooter of claim 5, wherein the data processing circuit is further configured to:
skip identifying the first direction towards the first target location if the first distance is greater than a predetermined distance-threshold.

7. The electric scooter of claim 5, wherein the data processing circuit is further configured to:
determine a first score corresponding to the first target location, based on the first distance and the first charging efficiency; and
skip identifying the first direction towards the first target location if the first score is less than a predetermined score-threshold.

8. The electric scooter of claim 7, wherein the data processing circuit is further configured to:
obtain second data received by the receiver, the second data comprising a second target location and a second battery charging efficiency at the second target location.

9. The electric scooter of claim 8, wherein the data processing circuit is further configured to:
if a distance between the first target location and the second location is within a predetermined range, ignore the obtained second data.

10. The electric scooter of claim 8, wherein the data processing circuit is further configured to:
in response to the second charging efficiency is greater than the current charging efficiency and the first charging efficiency:
identify a second direction towards the second target location;
determine a second set of one or more movements; and
send control signals to the steering assembly causing the steering assembly to execute the second set of one or more movements.

11. The electric scooter of claim 8, wherein the data processing circuit is further configured to:
determine a second distance between the current location and the second target location;
determine a second score corresponding to the second target location, based on the second distance and the second charging efficiency;
select a candidate location from the first target location and the second target location by comparing the first score and the second score;
identify a third direction towards the candidate location;
determine a third set of one or more movements; and
send control signals to the steering assembly causing the steering assembly to execute the third set of one or more movements.

12. The electric scooter of claim 1, further comprising:
one or more proximity sensors, wherein the one or more proximity sensors are able to detect proximities of objects relative to the electric scooter.

13. The electric scooter of claim 12, wherein the data processing circuit is further configured to:
in response to an obstacle in the identified direction being detected by the one or more proximity sensors, send control signals to the steering assembly causing the electric scooter to stop moving.

14. The electric scooter of claim 12, wherein the data processing circuit is further configured to:
in response to an obstacle in the determined direction being detected by the one or more proximity sensors, send control signals to the steering assembly causing the electric scooter to avoid the obstacle.

15. The electric scooter of claim 13, wherein the data processing circuit is further configured to:
after avoiding the obstacle, determine a new set of one or more movements for the steering assembly to execute.
